(19) United States
(12) Patent Application Publication
(10) Pub. No.: US 2026/0260398 A1
(43) Pub. Date: Sep. 3, 2026

(54) FACILITATING EFFECTIVE GENERATION OF IMAGES BASED ON A DESIRED COLOR SET

(71) Applicant: Microsoft Technology Licensing, LLC, Redmond, WA (US)

(72) Inventors: Mingxi CHENG, San Jose, CA (US); Yuhui Yuan, Beijing (CN); Danqing Huang, Mountain View, CA (US); Varun Tandon, San Francisco, CA (US); Ji Li, San Jose, CA (US)

(21) Appl. No.: 19/064,394

(22) Filed: Feb. 26, 2025

(51) Int. Cl. G06T 11/00; G06T 11/40; G06T 11/60

(52) U.S. Cl. CPC G06T 11/10; G06T 11/40; G06T 11/60; G06T 2200/24

(57) ABSTRACT

Methods, computer systems, and computer storage media are provided for generating new images in association with a desired set of colors. In embodiments, a text prompt including a first color signal representing a textual description of a color and a second color signal representing a color code associated with the color is generated. Further, an image prompt is generated that includes a color-enhanced reference image generated in accordance with the color. The text prompt including the first color signal and the second color signal and the image prompt including the color-enhanced reference image are used to generate a new image, which may be presented via a user interface.

### BACKGROUND

Automated image generation oftentimes results in the generation of ineffective or undesired images. In particular, a color(s) desired to incorporate into an image may not be properly included in the generated image. For example, in some cases, users may have a particular color scheme in mind for a design and, as such, include specific color instructions in a query. However, such color specifications are not always respected by the image generation models, and can thereby lead to discrepancies between the user's vision and the generated result. Accordingly, unnecessary computing resource consumption may occur to generate another image and/or to modify the undesired image in accordance with the user preferences.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for embodiments described herein to facilitate generating images in accordance with a desired set of colors in an automated manner. To efficiently and effectively generate an image in accordance with a specified color(s), a text prompt is generated that represents desired colors to use in generating or recoloring an image. The text prompt may include a text description of desired colors as well as a color code (e.g., hex code) to represent the desired colors. Using a text description and a code representation of desired colors enables a more comprehensive and quality desired image. In addition to generating a text prompt, an image prompt is generated to provide an input image for use in image generation. In embodiments, the input prompt is generated to include a color-enhanced reference image. In this way, upon obtaining a desired reference image, the reference image may be processed to include desired colors. As such, a reference image may be adjusted to include colors desired by a user (e.g., as represented by color codes in the text prompt). Both the text prompt and the image prompt may be provided as input to an image generator. In some implementations, the image generator may be or include a diffusion model to generate an image in association with the text prompt and the image prompt. In this way, an effective image may be efficiently generated in a manner suitable to achieve a desired color appearance.

### BRIEF DESCRIPTION OF DRAWINGS

The technology described herein is described in detail below with reference to the attached drawing figures, wherein:

FIG. 1 is a block diagram of an exemplary system for generating images in accordance with a desired set of colors, suitable for use in implementing aspects of the technology described herein;

FIG. 2 is an example implementation for generating images in accordance with a desired set of colors, in accordance with aspects of the technology described herein;

FIG. 3 provides an example illustration of a color application, in accordance with embodiments described herein;

FIG. 4 provides an example pseudocode to identify text color for a recolored image, in accordance with aspects of the technology described herein;

FIG. 5 provides an example flow diagram of one implementation for generating images in accordance with a desired set of colors, in accordance with aspects of the technology described herein;

FIG. 6 provides an example method flow for generating images in accordance with a desired set of colors, in accordance with embodiments described herein;

FIG. 7 provides another example method flow for generating images in accordance with a desired set of colors, in accordance with embodiments described herein;

FIG. 8 provides another example method flow for generating images in accordance with a desired set of colors, in accordance with embodiments described herein;

FIG. 9 is a block diagram of an exemplary computing environment suitable for use in implementing aspects of the technology described herein; and

FIG. 10 is a block diagram of an exemplary large language model environment suitable for use in implementing aspects of the technology described herein.

### DETAILED DESCRIPTION

The technology described herein is described with specificity to meet statutory requirements. However, the description itself is not intended to limit the scope of this patent. Rather, the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

Generating images with customized designs is valuable to users, as it enables them to create unique, personalized visuals without needing advanced design skills. Whether for marketing materials, social media posts, graphical designs, etc., being able to craft tailored images based on specific criteria is valuable. In some cases, users may have a particular color scheme in mind for their designs, and they might include specific color instructions in their query. However, these color specifications are not always respected by the image generation models, which can lead to discrepancies between the user's vision and the generated result.

For example, some applications integrate models, such as Stable Diffusion XL (SDXL) for image generation to enable users to create designs based on a human designer-created blueprint or template that are fine-tuned using text and image-to-image technology. In this regard, users can enter a prompt with text and make subtle adjustments to refine the output, ensuring it meets their desired specifications. Leveraging text prompts and image-based transformations to create designs, however, often does not adhere to the color requirements specified in the prompt. For instance, diffusion models, which generate images by iteratively refining random noise into a coherent picture, often prioritize the overall structure and features of the image over adhering to specific color guidelines. In particular, diffusion models are trained to focus on the high-level composition and objects within the image. As such, while diffusion models can interpret colors, such models often fail to accurately reflect precise color choices. This discrepancy arises because the models may not be fully capable of locking in exact color parameters, leading to variations that may not match user expectations.

Further, such conventional implementations may unnecessarily consume computing resources. For instance, using a diffusion model to generate ineffective or undesired images can result in both unnecessary resources of computational time and memory when a diffusion model generates undesired images. In this regard, generating images that do not include a desired color scheme results in unnecessarily consumed computing resources, such as time, memory, and processing power as the model performs multiple iterations of the generation process before arriving at a result that may not meet the user's specifications. For instance, when an image is generated based on a prompt, the underlying model, such as a diffusion model, performs a series of complex computations, gradually refining random noise into a final image. In cases in which the generated image deviates from the specified color scheme, additional resources are required to reprocess or adjust the image, for instance, by re-executing image generation or applying manual corrections. In addition to consuming valuable time by requiring more iterations, such a process also consumes more memory and processing power to re-execute image generation and/or to use larger datasets or more intensive calculations to correct discrepancies.

As such, embodiments described herein facilitate generating images in association with a desired set of colors in an efficient and effective manner. In particular, embodiments described herein provide an enhanced image recolor pipeline that enables users to input queries related to color, and such color is autonomously applied in image generation, for example, during a text and image-to-image diffusion process. Accordingly, a user may specify a desired set of colors and, based on the input, automatically obtain a generated image that corresponds with the user's preferences. In accordance with embodiments described herein, the enhanced image recolor pipeline implements generation and utilization of color-enhanced text and color-enhanced images as input into the image generation model, thereby resulting in a generated image that is more suited or aligned with the desired colors. In this regard, manipulating text and images prior to using them for image generation enables generation of an image that includes a desired set of colors.

In particular, embodiments described herein efficiently and effectively generate an image in accordance with a specified color(s) using a diffusion model in an automated manner. To do so efficiently and effectively, a text prompt is generated that represents desired colors to use in generating or recoloring an image. The text prompt may include a text description of desired colors (e.g., blue and green) as well as a color code (e.g., hex code) to represent the desired colors. Using a text description and a color code representation of desired colors enables a more comprehensive and quality desired image. In embodiments, the text prompt is generated based on an obtained query (e.g., user-provided) query. An obtained query(s) may include text description and/or color codes. For instance, a user may specify a desired set of colors by names, such as orange and black, and/or may select a color sample presented on a screen to specify colors (which correspond with color codes). In some cases, a color prompt may be generated based on the obtained query and input to an artificial intelligence (AI) model to produce a color signal in a text format and a color signal in a code format for including in the text prompt (e.g., a text prompt suited for a diffusion model). In this way, the text prompt may include an elaboration or enhancement of the colors indicated in a user query. Further, in cases in which the obtained query does not include color codes, such as hex codes, the AI model may produce the color signal in the code format such that color codes may be used to facilitate image generation.

In addition to generating a text prompt, an image prompt is generated to provide an input image for use in image generation. In embodiments, the input prompt is generated to include a color-enhanced reference image. In this way, upon obtaining a desired reference image (e.g., as selected by a user), the reference image may be processed to include desired colors. In this way, a reference image may be adjusted to include colors desired by a user (e.g., as represented by color codes in the text prompt). The desired colors may be applied to the reference image in any number of ways. As one example, a solid region associated with the reference image is identified. A desired color is used to fill or modify the solid region with the desired color (e.g., randomly selected from a set of desired colors). Further, the non-solid region is filled or modified with any of the desired colors. For example, the non-solid region may be segmented into subregions, and any of the desired colors can be used to randomly fill such subregions. Accordingly, the reference image is modified in a way that utilizes user-desired colors to generate a color-enhanced reference image for inputting into an image generation model.

Both the text prompt and the image prompt may be provided as input to an image generator for use in generating an image that includes the desired colors. In some implementations, the image generator may be or include a diffusion model to generate an image in association with the text prompt and the image prompt. Using a color-enhanced text prompt and a color-enhanced reference image to generate a new or recolored image facilitates a desired output, thereby improving the user experience and reducing unnecessary utilization of computing resources which may otherwise be used to enhance or improve a result that does not appropriately incorporate desired colors. As described herein, the resulting recolored or new image generated from the image generator may be enhanced to generate the final image. For example, suitable text may be overlayed on the recolored image. Such text may be presented in a color selected to be visible and suitable to the desired colors. In this way, an effective image may be efficiently generated in a manner suitable to achieve a desired color appearance.

### Overview of Exemplary Environments for Facilitating Effective Generation of Images Based on a Desired Color Set

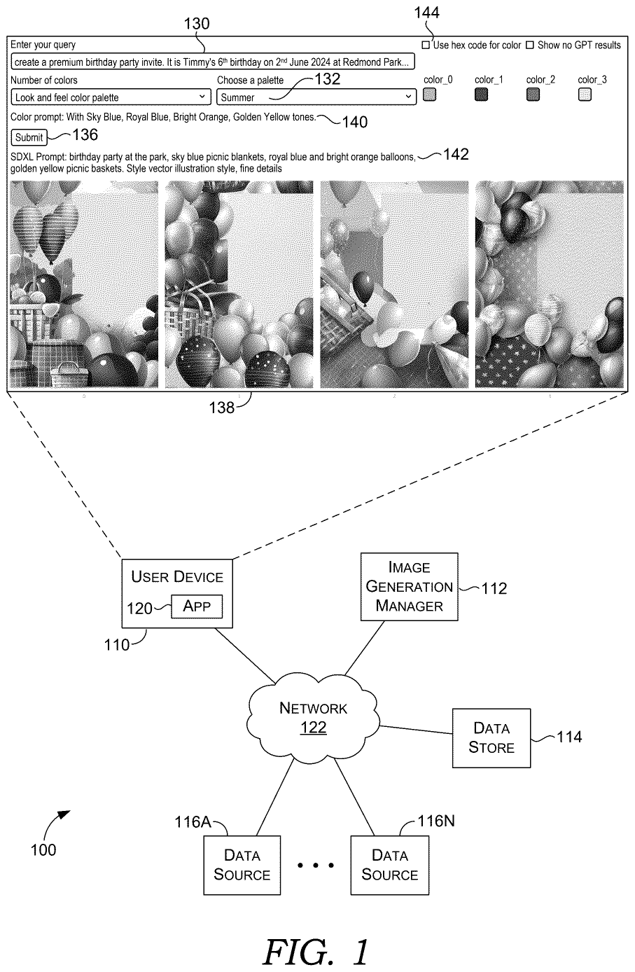

Referring initially to FIG. 1, a block diagram of an exemplary network environment 100 suitable for use in implementing embodiments described herein is shown. Generally, the network environment 100 illustrates an environment suitable for generating images in accordance with a desired color(s). In particular, an input image may be effectively and efficiently recolored based on a user-specified color(s). Among other things, embodiments described herein efficiently and effectively generate an image in accordance with a specified color(s) using a diffusion model in an automated manner. To do so efficiently and effectively, a text prompt is generated that represents desired colors to use in generating or recoloring an image. The text prompt may include a text description of desired colors as well as a color code (e.g., hex code) to represent the desired colors. Using a text description and a code representation of desired colors enables a more comprehensive and quality desired image. In addition to generating a text prompt, an image prompt is generated to provide an input image for use in image generation. In embodiments, the input prompt is generated to include a processed reference image. In this way, upon obtaining a desired reference image, the reference image may be processed to include desired colors. In this way, a reference image may be adjusted to include colors desired by a user (e.g., as represented by color codes in the text prompt). Both the text prompt and the image prompt may be provided as input to an image generator. In some implementations, the image generator may be or include a diffusion model to generate an image in association with the text prompt and the image prompt. As described herein, the resulting recolored image generated from the image generator may be enhanced to generate the final image. For example, suitable text may be overlayed on the recolored image. Such text may be presented in a color selected to be visible and suitable to the desired colors. In this way, an effective image may be efficiently generated in a manner suitable to achieve a desired color appearance.

The network environment 100 includes a user device 110, an image generation manager 112, a data store 114, and data sources 116a-116n (referred to generally as data source [s] 116). The user device 110, the image generation manager 112, the data store 114, and the data sources 116a-116n can communicate through a network 122, which may include any number of networks such as, for example, a local area network (LAN), a wide area network (WAN), the Internet, a cellular network, a peer-to-peer (P2P) network, a mobile network, or a combination of networks. The data store 114 may store any type or amount of data, including data accessible to the user device 110, the image generation manager 112, and/or the data sources 116. For example, the data store 114 may store color data, color signals, queries, reference images, processed reference images, recolored images, generated images, etc.

The network environment 100 shown in FIG. 1 is an example of one suitable network environment and is not intended to suggest any limitation as to the scope of use or functionality of embodiments disclosed throughout this document, and nor should the exemplary network environment 100 be interpreted as having any dependency or requirement related to any single component or combination of components illustrated therein. For example, the user device 110 and data sources 116a-116n may be in communication with the image generation manager 112 via a mobile network or the Internet, and the image generation manager 112 may be in communication with data store 114 via a local area network. Further, although the environment 100 is illustrated with a network, one or more of the components may directly communicate with one another, for example, via HDMI (High-Definition Multimedia Interface) and DVI (Digital Visual Interface). Alternatively, one or more components may be integrated with one another—for example, at least a portion of the image generation manager 112 and/or data store 114 may be integrated with the user device 110. For instance, a portion of the image generation manager 112 may be integrated with the user device (e.g., via application 120).

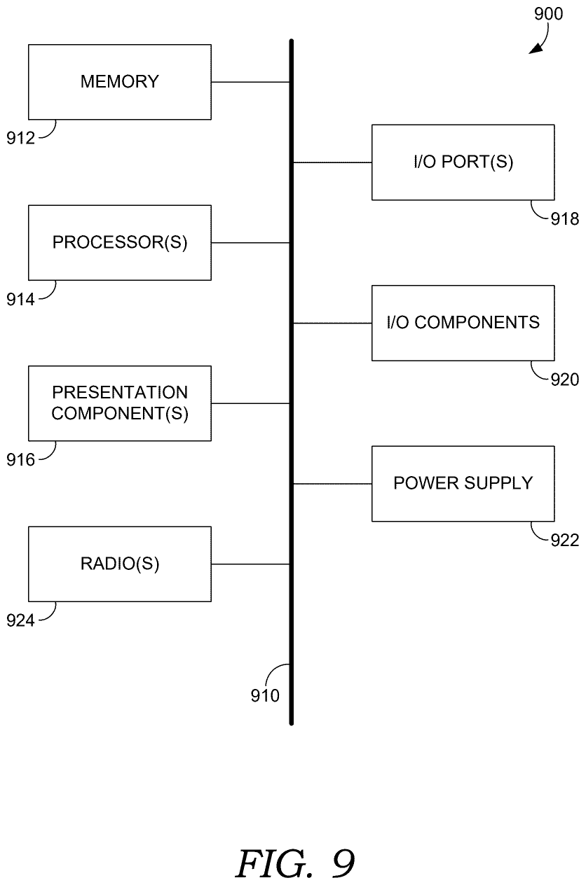

The user device 110 can be any kind of computing device capable of facilitating generation of an image in association with a desired set of colors. For example, in an embodiment, the user device 110 can be a computing device such as computing device 900, as described above with reference to FIG. 9. In embodiments, the user device 110 can be a personal computer (PC), a laptop computer, a workstation, a mobile computing device, a PDA, a cell phone, or the like.

The user device can include one or more processors and one or more computer-readable media. The computer-readable media may include computer-readable instructions executable by one or more processors. The instructions may be embodied by one or more applications, such as application 120 shown in FIG. 1. The application(s) may generally be any application capable of facilitating generation of an image in association with a desired color(s). Capabilities to generate images may be applied to a variety of applications across various domains—for example, to enhance creativity, to enhance quality designs, etc. In one example, an application may be a graphic design application or tool that automates part of the design process. In some cases, a graphic design tool may be powered by AI to assist users in creating designs quickly and efficiently. Images or designs that may be generated may correspond to various use cases, such as, for example, invitations, social media posts, cards, brochures, etc. In some cases, the graphic design tool may include or offer a range of templates (e.g., reference images) that may be tailored for specific use cases. The templates serve as a starting point for a user to customize using their own text, branding, color scheme, etc. The graphic design tool may also facilitate the user's customization, such as text, fonts, images, color scheme, and layout. One example of such a graphic design tool may be Microsoft Designer.

In this regard, in some cases, technology described herein may be used in association with graphic design tools or applications. In other cases, technology described herein may be used in association with other types of applications for which image generation may be desired. In yet other cases, technology described herein may be incorporated into an operating system or other system to generate images or designs. Any of such applications may include or access an AI assistant tool or technology that may facilitate image generation. As such, application 120 may be any type of application that may facilitate image generation in association with a set of desired colors. In some implementations, the application(s) comprises a web application, which can run in a web browser, and may be hosted at least partially server-side (e.g., via image generation manager 112). In addition, or instead, the application(s) can comprise a dedicated application. In some cases, the application is integrated into the operating system (e.g., as a service).

User device 110 can be a client device on a client-side of operating environment 100, while image generation manager 112 can be on a server-side of operating environment 100. Image generation manager 112 may comprise server-side software designed to work in conjunction with client-side software on user device 110 so as to implement any combination of the features and functionalities discussed in the present disclosure. An example of such client-side software is application 120 on user device 110. This division of operating environment 100 is provided to illustrate one example of a suitable environment, and it is noted that there is no requirement for each implementation that any combination of user device 110 and/or image generation manager 112 remain as separate entities.

In an embodiment, the user device 110 is separate and distinct from the image generation manager 112, the data store 114, and the data sources 116 illustrated in FIG. 1. In another embodiment, the user device 110 is integrated with one or more illustrated components. For instance, the user device 110 may incorporate functionality described in relation to the image generation manager 112. For clarity of explanation, embodiments are described herein in which the user device 110, the image generation manager 112, the data store 114, and the data sources 116 are separate, while understanding that this may not be the case in various configurations contemplated.

As described, a user device, such as user device 110, can facilitate generation of an image in accordance with a desired set of colors in an effective and efficient manner. A user device 110, as described herein, is generally operated by an individual or entity interested in initiating image generation. In some cases, image generation may be initiated at the user device 110. For instance, in some cases, a user may navigate to an AI tool interface (e.g., a chat box) or a text box and input a request to generate a particular image in accordance with one or more desired colors. As one example, the user input may include or be a natural language input by a user. A user input may include a request in the form of a question, command, or description of a desired image to be generated. Based on the input, generation of an image is initiated. For example, a user may navigate to an application and input a request to generate an image based on a particular reference image or template and/or in association with a particular color scheme.

As described, the user device 110 can include any type of application, which may be a stand-alone application, a mobile application, a web application, or the like. In some cases, the functionality described herein may be integrated directly with an application or may be an add-on, or plug-in, to an application.

The user device 110 may communicate with the image generation manager 112 to initiate image generation. In embodiments, for example, a user may utilize the user device 110 to initiate image generation in association with a color scheme via the network 122. For instance, in some embodiments, the network 122 may be the Internet, and the user device 110 interacts with the image generation manager 112 to initiate generation of an image. In other embodiments, for example, the network 122 may be an enterprise network associated with an organization. In yet other embodiments, the image generation manager 112 may additionally or alternatively operate locally on the user device 110 to provide local responses. It should be apparent to those having skill in the relevant arts that any number of other implementation scenarios may be possible as well.

With continued reference to FIG. 1, the image generation manager 112 can be implemented as server system(s), program module(s), virtual machine(s), component(s) of a server or servers, networks, and the like. At a high level, the image generation manager 112 manages image generation in association with a desired color(s). In embodiments, at a high level, to generate a desired image, an image generator, such as a diffusion model, may obtain as input a text prompt and an image prompt. The text prompt generally includes color signals to signal or indicate a desired color. In embodiments, the color signals include a text description and a color code (e.g., hex code). The image prompt generally includes a reference image, such as a processed reference image, to adjust in association with the color signals. In embodiments, a processed reference image refers to a reference image that is processed, for example, in association with the color signals included in the image prompt. In this way, the processed reference image provided as input to the image generator includes desired colors.

A reference image that may be selected for use as a basis for generating an image may be obtained from various data sources, such as data sources 116. For example, one data source may include various reference images associated with one type of product (e.g., invitations), while another data source may include reference images associated with another type of product (e.g., cards or announcements). As another example, one data source may include reference images generated by a first content creator, while another data source may include reference images generated by a second content creator. Such reference images may be in any number of formats (e.g., sizes, colors, contents, etc.). As such, data sources 116 may include various types of reference images.

In accordance with generating a recolored image (e.g., based on the text prompt and the image prompt), a text color may also be identified and applied to generate a final image. Using color data as described herein enables generation of a more suitable and effective design or image to be generated. Such a generated image may be stored in data store 114. In some cases, the data may be stored in a particular manner. For instance, a generated image may be stored in association with a certain user or set of users. As another example, a generated image may be stored as a reference image for subsequent use in generating images. Additionally or alternatively, a generated image may be communicated to the user device 110 for presenting and/or using by a user of the user device.

By way of example only, assume a user provides an input text 130 and an input color indication 132. In accordance with a user selecting to generate an image via submit button 136, various images 138 may be generated. Any number of images may be generated to provide various candidate images for a user to select a desired image. In some cases, a color signal 140 that is generated based on the input color indication 132 may be presented to a user. In this way, the text prompt, or a portion thereof (e.g., a text color signal), may be presented for the user to view prior to or in association with initiating generation of an image. Similarly, in some cases, an image signal 142 that is generated based on the input text 130 may also be presented to a user. As such, the text prompt, or a portion thereof (e.g., image signal), may be presented for the user to view prior to or in association with initiating generation of an image. In some cases, the color signal 140 and the image signal 142 may be aggregated into a single text prompt that is input into an image generator. In other cases, the color signal 140 and the image signal 142 may be provided in separate text prompts provided as input into an image generator. Further, as shown, in some cases, use of a color code 144 may be user-selectable. In this way, in cases in which a user selects to use color codes, the color codes (e.g., hex codes) may also be used to generate a color signal for providing in a text prompt for image generation. Various user interfaces may be implemented to obtain queries and/or to display generated images, and this is provided as one example only and not intended to limit the scope of the embodiments described herein.

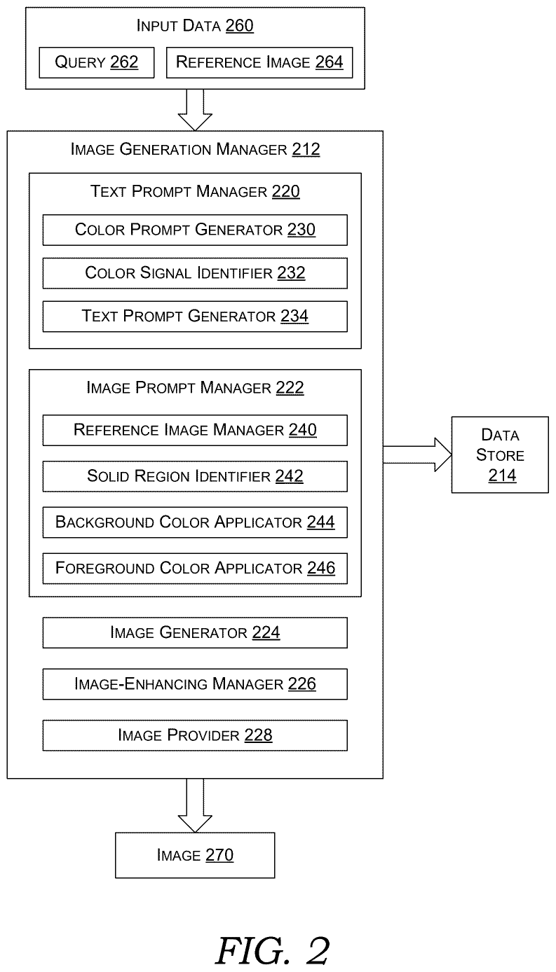

Turning now to FIG. 2, FIG. 2 illustrates an example implementation for generating images in accordance with a desired color scheme via image generation manager 212. The image generation manager 212 is communicatively coupled with the data store 214. The data store 214 is configured to store various types of information accessible by the image generation manager 212 or another server or device. In embodiments, data sources (such as data sources 116 of FIG. 1), user devices (such as user devices 110 of FIG. 1), and/or image generation manager (such as image generation manager 212) can provide data to the data store 214 for storage, which may be retrieved or referenced by any such component. As such, the data store 214 may store queries, color data, color signals, reference images, processed reference images, and/or the like.

In operation, the image generation manager 212 is generally configured to manage generating images in association with a desired color scheme in an efficient and effective manner. In embodiments, the image generation manager 212 includes a text prompt manager 220, an image prompt manager 222, an image generator 224, an image-enhancing manager 226, and an image provider 228. According to embodiments described herein, the image generation manager 212 can include any number of other components not illustrated. In some embodiments, one or more of the illustrated components 220, 224, 226, and 228 can be integrated into a single component or can be divided into a number of different components. Components 220, 222, 224, 226, and 228 can be implemented on any number of machines and can be integrated, as desired, with any number of other functionalities or services.

Turning initially to the text prompt manager 220, the text prompt manager 220 is generally configured to manage generation of a text prompt for performing image generation. In this regard, a text prompt is generated for input to the image generator 224 to use to generate an image(s). In accordance with embodiments described herein, the text prompt is generally configured to include a color signal(s) in addition to imagery signal(s) such that an indication of a desired color(s) is provided and used by the image generator to generate a desired image.

At a high level, generation of a text prompt may be initiated in any number of ways. In some cases, such generation may be initiated based on the image generation manager 212, or another component such as the text prompt manager 220, receiving a query 262 as input data 260 that indicates a request to generate an image. In some embodiments, a query may be obtained at image generation manager 212 based on user input. For example, a user operating a user device may provide input (e.g., in the form of a query or natural language utterance) or select to initiate generation of an image. In such cases, the user may provide an indication of a desired image. For example, the user may specify various attributes associated with an image desired to be generated (e.g., various visual attributes or text). As one example, assume the image generation manager 212 executes in association with a visual design application for designing invitations. In such a case, the query may include a desired theme, colors, text, etc.

Such user-provided input may be provided via an input text box in a user interface associated with an application executing at the user device. As one example, an input text box may be presented via a display such that text input (e.g., a question, command, or other natural language utterance) from the user may be provided to generate an image. Although described as text input, other types of input may be provided. For instance, a verbal input may be provided to trigger or initiate image generation.

Additionally or alternatively, a query, such as query 262, may be automatically triggered based on an occurrence of an event. For example, in accordance with selecting visual or content preferences in association with a design, a query may be automatically triggered to initiate generation of an image.

In accordance with initiating generation of an image or design, the text prompt manager 220 is generally configured to manage generation of a text prompt for use in generating an image. To do so, in some embodiments, the text prompt manager 220 may include a color prompt generator 230, color signal identifier 232, and a text prompt generator 234. In this way, a color prompt generator 230 may generate a color prompt that is used by the color signal identifier 232 to generate a color signal(s). Such a color signal(s) can be used by the text prompt generator 234 to generate a text prompt that includes the color signal(s). Accordingly, a text prompt provided to an image generator indicates or provides context to desired colors for the image in an effective manner, such that the image is generated in an aesthetically desired manner.

The color prompt generator 230 is generally configured to generate a color prompt. A color prompt refers to a prompt that may be provided to the color signal identifier to identify color in a text format for use in generating an image(s). In some cases, a color prompt is generated by the color prompt generator 230 based on a user's input. Accordingly, to generate a color prompt, the color prompt generator 230 may obtain a query(s) 262 provided as input data 260. In embodiments, a query(s) may be provided via an application executing on a user device. For example, a query may be provided or initiated by a user operating on a user device.

A query may be provided or obtained in any number of formats. In one example, a query may be provided as a text query input by a user. A text query refers to a query that textually describes a color (e.g., blue, light green, etc.). For instance, a user may provide a text query that indicates a desired color to use in association with an image. A text query may be input in any manner. As one example, a text query may be provided via text input into a text box. As another example, a text query may be provided via verbal input.

A text query may include any granularity of color detail. As one example, a text query may include a more general description of a color or set of colors to use. For instance, a text query may specify to use summer colors. As another example, a text query may include a more detailed or specific description of a color or a set of colors to use. For instance, a text query may specify to use light blue, dark blue, orange, and yellow colors. In some cases, the text query may include a desired color(s) in addition to other desired image attributes. For example, the text query may specify colors to use for a theme-based invitation. In other cases, the text query may be specific to the desired color(s).

Additionally or alternatively, a query may be provided as a color query, for example, input by a user. A color query may include an indication of a color or color palette using a color code or color value. In this way, a user may select a displayed color to generate a query. One example of a color value is hexadecimal code, also referred to as hex code. Hex code is used to transmit color information in a 6-character string that represents the color in a red, green, blue (RGB) color model. Other example color values include RGB values, HSL (hue, saturation, lightness), RGBA (red, green, blue, alpha), etc. In this regard, assume a user selects a color sample on a display screen (e.g., clicking on a color in a color picker or selecting a hue from a color palette). In such a case, the corresponding color value (e.g., hex code) may be identified and transmitted for processing. In this way, the color prompt generator 230 may obtain one or more color values via a color query.

Any number of queries may be obtained in association with a color. For example, for a particular image to be generated, a text query and/or a color query may be obtained. In some cases, an obtained query may include both a text description of a color and a code associated with a color. In other cases, separate queries may be obtained, one providing a text description of a color(s) and another providing a color code(s). Further, different queries may be obtained in association with different color sets. For example, a first query may be obtained in association with a first color, and a second query may be obtained in association with a second color.

Upon obtaining a query(s) associated with a color, the color prompt generator 230 may use the color data (e.g., text description and/or color code) provided in the query(s) to generate a color prompt. Accordingly, the color prompt may include textual color descriptions and/or color codes, for example, obtained from a text query and/or a color query. In this way, a color prompt may combine various color data to more comprehensively describe desired colors. In other cases, a color prompt may include only text descriptions or only color codes, for example, depending on the type of data obtained via one or more queries.

A color prompt may include additional data. As one example, a color prompt may include an instruction to produce a code signal(s) for an image to be generated. For instance, a color prompt may provide an instruction to generate a code signal based on a color text description(s) and a code signal based on a color code(s). A color prompt may also include one or more output attributes indicating a desired output. For instance, the color prompt may request an output of a color signal in the form of a hex code.

The color prompt generator 230 may provide generated prompts to the color signal identifier 232 to initiate execution of the prompts. In this way, the color prompt generator 230 may communicate the generated prompt to the color signal identifier 232 to generate a response thereto.

The color signal identifier 232 is generally configured to facilitate identification of color signals for use in generating an image. Generally, color signals represent colors in a textual manner. Color signals may represent colors in various ways. As one example, a color signal may represent a color using a textual description of a color. As another example, a color signal may represent a color using a color code, such as a hex code. In operation, the color signal identifier 232 may take the color prompt as input and, in response, generate an output or response that identifies one or more color signals for use in generating an image(s). In this way, the color signal identifier 232 is generally configured to interpret a color prompt and convert to appropriate color signals, as represented by color names, descriptions, codes, and/or other values representing colors.

In embodiments, the color signal identifier 232 may be, include, or reference, one or more AI models, such as generative AI models. In this regard, the color signal identifier 232 may use or access AI technology to facilitate generation of a response to an input color prompt. By way of example, the color signal identifier 232 may provide the color prompt into an AI model, such as a large language model (LLM), and, in response, obtain a color signal(s). As described, a response and/or color signal may be in any format. In some cases, the form of a response may depend on a particular desired format included in the color prompt. For example, the color prompt may request a color signal providing a color description in textual form or natural language form and a color signal providing hex codes for the colors.

To identify or produce a color signal in the form of a text color description, the color signal identifier 232 may use the color data in the form of text description in the color prompt to facilitate generation of such a color description. For example, assume a color prompt includes an input user query that specifies “summer colors” for use in generating an image. In such a case, the color signal identifier 232 may use the description of summer colors to produce a color signal of “with sky blue, royal blue, bright orange, and golden yellow tones.” To generate a color signal in the form of a text color description, an AI model, such as an LLM, may take into account various considerations. For example, an AI model may recognize colors that are complementary, analogous, or part of a same color family (e.g., warm or cool tones), associate colors with objects, scenes, moods, or themes (e.g., use cultural, natural, or visual references to associate colors with specific items or events), use adjectives to describe how colors look or feel (e.g., soothing, vibrant, soft, bold, etc.), describe combinations and/or placement (e.g., contrast between two colors, etc.), and/or the like.

To identify or produce a color signal in the form of a color code (e.g., hex code), the color signal identifier 232 may use color data in the form of a text description in the color prompt or a color code in the color prompt. For example, in instances in which a color code is provided in the color prompt, the color signal identifier 232 may preserve the color code as a color signal. On the other hand, in instances in which a color code is not provided (e.g., only a text color description is provided), the color signal identifier 232 may generate or produce the hex code based on the provided text color. For example, assume a color description of “light blue” is provided. In such a case, the color signal identifier 232 may provide the hex color code of #ADD8E6 as output.

In some cases, the color signal identifier 232 may iteratively process color prompts to identify color signals. For example, assume that a user provides a query specifying “summer colors.” In such a case, a first color prompt may be generated that includes “summer colors,” and the color signal identifier 232 may generate a color signal of light blue and yellow. Thereafter, to generate a color signal in the form of a color code, a second color prompt may be generated that includes “light blue” and “yellow,” and the color signal identifier may generate a color signal of hex code #ADD8E6 to represent the “light blue” color and a hex code of #FFF00 to represent the “yellow” color.

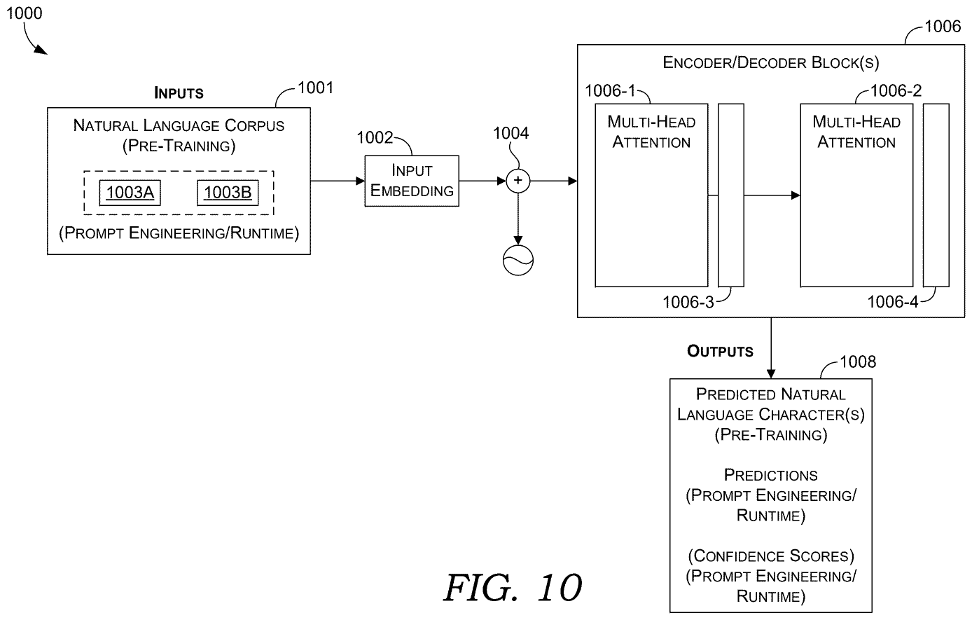

As described, the color signal identifier 232 may be, include, or access any number of AI models or technologies. In some cases, a machine learning model in the form of an LLM is used to generate color signals. A language model is a statistical and probabilistic tool that determines the probability of a given sequence of words occurring in a sentence (e.g., via next sentence prediction [NSP] or masked language model [MLM]). Simply put, it is a tool that is trained to predict the next word in a sentence. A language model is called a large language model when it is trained on an enormous amount of data. In particular, an LLM refers to a language model including a neural network with an extensive amount of parameters that are trained on an extensive quantity of unlabeled text using self-supervising learning. Oftentimes, LLMs have a parameter count in the billions, or higher. Some examples of LLMs are GOOGLE's BERT and OpenAI's GPT-2, GPT-3, and GPT-4. For instance, GPT-3 is a large language model with 175 billion parameters trained on 570 gigabytes of text. These models have capabilities ranging from writing a simple essay to generating complex computer codes-all with limited to no supervision. Accordingly, an LLM is a deep neural network that is very large (billions to hundreds of billions of parameters) and understands, processes, and produces human natural language by being trained on massive amounts of text. Although some examples provided herein include a single-mode generative model, other models, such as multimodal generative models, are contemplated within the scope of embodiments described herein. Generally, multimodal models are generated to make predictions based on different types of modalities (e.g., text and images). In some embodiments, the color signal identifier 232 takes on the form of or uses an LLM, but various other AI models or technologies can additionally or alternatively be used. One example of an LLM is provided below in reference to FIG. 10. Other models or technology may be used herein, including but not limited to, small language models.

The text prompt generator 234 is generally configured to generate a text prompt for input to an image generator. In this regard, a text prompt is generated for inputting to the image generator to generate an image. In accordance with embodiments described herein, the text prompt generally includes one or more color signals indicating or representing colors to use in generating an image. In embodiments, the text prompt may include the color signals in a descriptive text format (e.g., a natural language format) and a color code format (e.g., hex code). For example, a text prompt may include an indication of a text color description (e.g., with sky blue, royal blue, bright orange, golden yellow tones, etc.) and an indication of corresponding hex codes. As described, such color signals may be generated or identified via the color signal identifier 232.

In addition, a text prompt may include other image attributes in the form of an image attribute signal(s). In this regard, a text prompt may include attributes that describe non-color features desired for an image. Non-color features may indicate themes, objects, patterns, etc. In some cases, an image attribute signal(s) for a text prompt may be derived from or based on a query, such as an input user query. For example, in accordance with an obtained query, the text prompt generator 234 may identify such image attributes and include the image attributes in the text prompt. For instance, assume a user query is an invitation for a new product launch. In such a case, the text prompt generator 234 may include the exact input in the text prompt. As another example, in accordance with an obtained query, the text prompt generator 234 may identify such image attributes and generate or derive a corresponding image attribute signal(s) to guide the image generation process. In some cases, such an image attribute signal may be generated using an AI model. For instance, a query might be automatically expanded or modified using an AI model, such as a generative AI model. By way of example only, assume a query of “generate a themed futuristic city invitation” is obtained. In such a case, an AI model may expand the text to be “a futuristic city skyline at night, glowing with neon lights, flying cars, cyberpunk style, highly detailed, vibrant colors,” which may be included in the text prompt as an image attribute signal. In this way, a model may use its trained understanding of common visual concepts to enrich or elaborate on a query into a full, detailed text prompt that guides the generation process more effectively. In some cases, a model used to generate color signals may also be used to generate an image attribute signal(s). For instance, a same AI model may be used to output color signals and image attribute signals. Such signals may be output based on a single input prompt or multiple input prompts (e.g., one prompt to generate color signals and another prompt to generate image attribute signals).

In accordance with generating color signals and/or image attribute signals, the text prompt generator 234 can aggregate such signals to generate a text prompt for input into an image generator. As one example, a color signal in the form of a text color description and a color signal in the form of a color code may be appended to an image attribute signal (e.g., a text description of non-color features of a desired image) to generate a text prompt. In this regard, a text prompt may be infused with various color signals to indicate or represent colors for a desired image.

In addition to color and/or image attribute signals, a text prompt may include other data. For example, a text prompt may include an instruction or request to generate an image in accordance with the provided color signals and/or image attribute signals. As another example, output attributes associated with a desired output may be provided, such as a desired size for an image, a desired number of colors for an image, etc.

The generated text prompt may be provided as input to the image generator 224. In this way, the image generator 224 may generate an image in accordance with the various color signals and/or image attribute signals provided in text format via the text prompt.

The image prompt manager 222 is generally configured to manage generation of an image prompt for performing image generation. In this regard, an image prompt is generated for input to the image generator 224 to use to generate an image(s). An image prompt generally refers to a prompt that may be provided in the form of an image to the image generator. In other words, an image prompt refers to an input image that is used to guide or influence the image generation process. In accordance with embodiments described herein, the image prompt may be configured to represent desired colors such that an image can be generated therefrom in a desired manner.

In accordance with initiating generation of an image, the image prompt manager 222 is generally configured to manage generation of an image prompt for use in generating an image. To do so, in some embodiments, the image prompt manager 222 may include a reference image manager 240, a solid region identifier 242, a background color applicator 244, and a foreground color applicator 246.

The reference image manager 240 is generally configured to obtain a reference image, such as reference image 264, for use in generating an image. A reference image refers to an image that may be used as a visual guide or source of inspiration for generating an image. The reference image may influence the creation, modification, or interpretation of another image. As such, the reference image may serve as a basis or starting point from which inspirations may be drawn. Reference images may be in any format or correspond with any type of content. As examples, reference images may be designed invitations, photographs, graphic designs, or other artistic creations.

A reference image may be specified in any number of ways. As one example, a user may select a reference image, such as reference image 264, that is presented on a display for use in manipulating. In particular, a user may navigate to a particular image and select such an image to use as a reference image. In embodiments, a set of reference images may be generated and stored (e.g., in data store 214) as predesigned blueprints or design templates. In some cases, the reference images may be created by a user or other individual(s). For instance, images may be generated by content producers or generators (e.g., third-party resources) and stored in data store 214 as reference images.

In some cases, the reference image manager 240 may remove text provided on the reference image. For instance, assume a reference image includes template text or default text (e.g., text in a pregenerated invitation template). In such a case, the reference image manager 240 may remove the text to have a textless reference image. In this way, a textless reference image may be used as input into the image generator 224.

The solid region identifier 242 is generally configured to identify a solid region of the reference image. A solid region generally refers to a continuous area where pixels share similar properties, such as color, intensity, and/or texture, and typically appear as a homogenous or uniform part of the image. In this regard, a solid region is generally distinct from surrounding areas, making it visually identifiable as a block or patch that has a certain level of consistency. For example, a solid region may include a uniform amount of pixels in the region, such that they have minimal variation in color, brightness, or texture. As another example, a solid region generally forms a connected component of an image, such that pixels in the region are adjacent to each other or closely connected without gaps. As yet another example, a solid region is often in contrast with the surrounding areas (e.g., due to the region's color or intensity being distinct from adjacent regions). In embodiments described herein, a solid region may be used for providing text placement or as a background of the image. In this regard, a solid region may be identified for recoloring pixels and/or overlaying text.

In some embodiments, a primary solid region is identified. That is, a greatest or largest solid region is identified. In other embodiments, any number of solid regions may be identified. For example, solid regions greater than a threshold size may be identified.

To identify a solid region, various approaches may be used, such as thresholding, segmentation, and/or edge detection. In one approach, the solid region identifier 242 may identify a solid region using a segmentation algorithm (e.g., a foreground/background segmentation algorithm) to recognize placement of a solid area(s) and placement of a non-solid area(s). In using such a segmentation algorithm, in embodiments, K-means clustering may be performed to cluster pixels associated with a similar color. In this way, K-means clustering may be performed on the RGB values of the image pixels to segment the image into distinct clusters. “K-means” generally refers to an unsupervised learning algorithm that attempts to find clusters by grouping similar data points (e.g., cluster pixels with similar color, such as RGB values within a predefined threshold parameter). In some cases, the number of clusters, n, is predefined. For example, the number of clusters may be set to 10 to split the image into that many distinct regions based on pixel similarity (e.g., each pixel may be represented by an RGB value). In operation, K-means may be used to assign each pixel to a nearest cluster center. The centroids can be updated to be a mean RGB value of the assigned pixels. Such a process may be repeated until the centroids stabilize.

In accordance with generating clusters, a majority cluster or primary cluster may be identified. In this way, the solid region identifier 242 may determine which cluster contains the most pixels that correspond to a dominant solid color or which cluster represents the dominant solid color in the image (e.g., the cluster with the highest number of pixels). In one implementation, unique labels and corresponding pixel counts for each cluster may be determined (e.g., how many pixels belong to each cluster). Thereafter, the cluster with the maximum pixel count may be identified as representing the dominant color or representing the solid color region.

An RGB value associated with the majority cluster may be retrieved, obtained, or extracted. In some cases, the dominant RGB value may be obtained by calculating the centroid of that cluster. The centroid represents the average color of the pixels in that cluster, which may be referred to as the dominant color (e.g., for use in identifying the solid region).

Thereafter, a mask may be generated to identify or highlight pixels in the image that match the dominant color. In this regard, a binary mask may be created to identify regions of the image that match the solid color. In one example, the Euclidean distance between each pixel's RGB values and the dominant color's RGB values may be determined. In cases in which the Euclidean distance between a pixel and the dominant color is below a predefined threshold, the pixel may be identified as being close enough to the dominant color and thus belonging to the solid region. In accordance with performing a pixel-by-pixel analysis, a mask (e.g., binary mask) may be created to correspond with the solid region. For instance, pixels that match the solid color (e.g., have a low Euclidean distance) may be represented as 1, and all other pixels represented as 0.

The solid region identifier 242 may perform such a process in an iterative manner to refine the solid region. For example, as the image is processed pixel by pixel, the region for the solid color may change or expand (e.g., neighboring pixels may also match the solid color). As such, if a pixel is identified as part of the solid region (e.g., based on a threshold), the dominant color may be updated by recalculating a new centroid of the expanded region. Dynamically determining the dominant color to refine the region ensures that as more pixels join the solid region, the dominant color is updated accordingly and enables the mask to expand dynamically to reflect the solid color region's boundary.

In embodiments, the solid region identifier 242 may also reshape the mask, for example, to match the original dimensions of the image (e.g., height and width). By way of example only, because images may be large, the process of computing pixel by pixel can be time-consuming and, as such, the image may be downsampled to reduce its size for faster processing. Once the mask is generated for the downsampled image, the solid region identifier 242 may upsample the downsampled image back to match the original dimensions of the image. Such upsampling ensures that the mask correctly overlays the original image dimensions and can be applied effectively.

The background color applicator 244 is generally configured to apply a background color to the solid area. In this regard, based on the identified solid region identified via the solid region identifier 242, a desired color can be applied to the solid region. In embodiments, the particular color to apply as the background color to the solid region may be based on a color corresponding with a user-desired color. As one example, a background color may be selected using a color signal identified via the color signal identifier or included in the text prompt generated by the text prompt generator 234. For instance, hex codes identified as a color signal or included in a text prompt may be referenced and used to select one of the hex codes to apply to the solid region as a background color. In some cases, a color (e.g., represented by hex codes) is randomly selected to apply to the pixels of the solid area. In other cases, a color may be selected based on predefined rules, user preferences, color attributes, etc. For instance, a darkest color, a lightest color, a most neutral color, a most vibrant color, etc., may be selected.

In accordance with selecting a background color, the background color applicator 244 may apply the selected color to the solid region. For example, in embodiments, the generated mask can be used to replace the pixels corresponding to the solid color region with the newly selected solid region. Such a process may include iterating over the image and checking the mask. If a pixel is part of a solid region (e.g., has a value of 1 or True in the task), the color is changed to the newly selected color. Otherwise, the pixels remain unchanged.

The foreground color applicator 246 is generally configured to apply foreground colors to the non-solid regions in an image. The non-solid regions may be identified as any areas not identified as solid regions. For non-solid regions, any number of colors may be used. As such, multiple colors applied to non-solid regions may be more strategically identified and/or applied to ensure image generation quality. For example, multiple colors may be desired to be strategically applied such that the image input into the image generator can be used to produce desired color imagery results with variety and non-rigid color blocks. Further, it may be desirable to apply colors to the foreground in a manner that ensures that original foreground patterns are preserved to trigger the best image-to-image effect. For example, applying colors randomly by squares may result in a lack of a suitable preservation of colors.

In one example implementation, the foreground color applicator 246 may divide the image (e.g., output from the background color applicator 244) into regions. In one embodiment, Voronoi regions may be used for segmenting the image. In particular, the non-solid regions may be identified or referenced for applying a foreground color. The Voronoi diagram algorithm may be used to divide such regions into smaller, irregular subregions. Generally, the Voronoi algorithm generates regions where each point in a region is closer to a particular “seed” point than to any other seed point, resulting in a set of distinct regions. Such subregions represent individual blocks or areas in which a foreground color can be applied.

In accordance with dividing non-solid regions into subregions, such as Voronoi regions, a color may be assigned to each subregion. In embodiments, the particular color to apply as the foreground color to a subregion may be based on a color corresponding with a user-desired color. As one example, a foreground color may be selected using a color signal identified via the color signal identifier or included in the text prompt generated by the text prompt generator 234. For instance, hex codes identified as a color signal or included in a text prompt may be referenced and used to select one of the hex codes to apply to a non-solid subregion as a foreground color. In some cases, a color (e.g., represented by hex codes) is randomly selected to apply to the pixels of a non-solid subregion. In this regard, each subregion may be randomly assigned a color (e.g., a color represented by the hex codes that is not used as a background color). In other cases, a color may be selected based on predefined rules, user preferences, color attributes, etc. For instance, an order of color selection may relate to color tones, contrasting colors, etc.

The foreground color applicator 246 may then apply the selected colors to the various non-solid subregions. In some cases, to ensure the recolored subregions blend naturally with the original image, the colors may be blended with a grayscale version of the original image. Such a blending may ensure that the recolored subregions retain some of the underlying tonal characteristics of the original image, thereby preserving some of the original depth and texture and preventing colors from being too distracting.

Further, in some cases, the foreground color applicator 246 may extract edges from the original image using edge detection techniques. As such, boundaries and contours (e.g., object outlines or significant features) in the image may be identified. Upon applying the foreground colors, the extracted edges can be overlayed onto the recolored version. This ensures that the edges of objects or areas in the image remain visible after the colors have been applied and also facilitates preservation of the structure and texture of the image.

The color-enhanced reference image, or processed reference image, may be used as input or an image prompt to provide to the image generator. In this way, after an initial reference is processed, modified, or manipulated, for example, to add background and foreground color, the image prompt manager 222 may provide such a color-enhanced reference image as an image prompt to the image generator for use in generating an image.

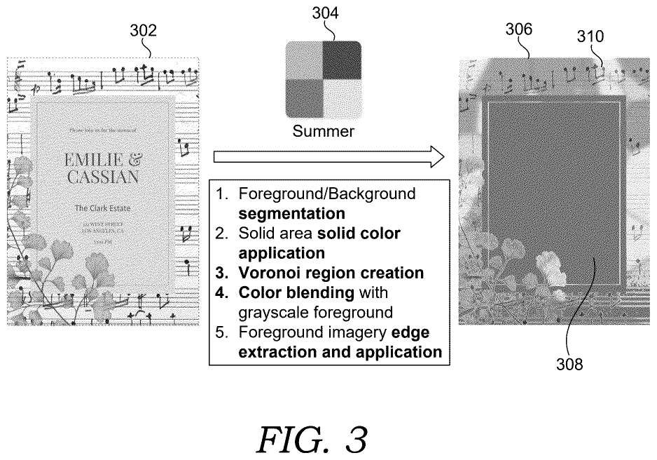

FIG. 3 provides an example illustration of a color application in accordance with a reference image, in accordance with embodiments described herein. In this example, reference image 302 is provided as input, for example to the image prompt manager 222. Further, assume color data, such as hex codes associated with the color palette 304, is obtained. In such a case, to generate the color-enhanced reference image 306, the various color data of the color palette 304 may be used to apply a background color 308 and various foreground colors 310 to the reference image 302. For example, as described, a solid region and non-solid region segmentation may occur. The identified solid region may be applied with a randomly selected background color, orange, of the color palette 304. For the non-solid region(s), Voronoi subregions may be identified. Using foreground colors randomly assigned from the color palette 304 to the various subregions, the colors may be applied accordingly. In applying the foreground colors, color blending may occur with grayscale foreground. Further, foreground imagery edge extraction and application may be applied such that the edges are apparent despite the foreground color application.

Returning to FIG. 2, the image generator 224 is generally configured to generate an image(s). In particular, the image generator 224 uses a text prompt (e.g., generated by the text prompt manager 220) and an image prompt (e.g., generated by the image prompt manager 222) to generate a corresponding image(s). In this regard, the image generator 224 generally generates a recolored image from the image (e.g., processed reference image) to the image generator.

The image generator 224 may include or use any type of technology to generate images. In one embodiment, a stable diffusion model may be used to generate images. A stable diffusion model may be used for text-to-image generation, image-to-image generation, and/or text and image-to-image generation. In this regard, a stable diffusion model may take as input a text prompt and an image prompt and output an image generated based on the input. One example of a stable diffusion model that may be used is SDXL, which refers to an enhanced version of a stable diffusion model (e.g., improvements directed to generating more detailed, coherent, and higher-quality images). SDXL can handle more complex prompts and produce better results in creative tasks, such as image manipulation, recoloring, and/or other transformations. SDLX is a type of generative model that iteratively refines images from noise, guided by text and image inputs.

As one example implementation, the image generator 224 may generate a recolored image by combining information from both an input text prompt (e.g., that includes color signals) and an input image (e.g., that is processed to include desired colors) using a multi-stage process. In embodiments, the image generator 224 may extract features from the input image (e.g., the processed reference image) to understand the image's content, texture, and/or structure. The input text prompt may be processed by a text encoder to convert the text into a latent representation that captures the information provided in the text. Thereafter, a cross-attention mechanism may be used to align and combine the information from both the image prompt and the text prompt. In this way, while the input image is being processed, details from the text prompt are used to guide the transformation process. A diffusion model is used to gradually denoise the input image, for example, starting from random noise and iteratively refining it based on the text. The extracted features from the input image and the text may be used to adjust the latent image representation, guiding to a final recolored version that adheres to the instructions in the text prompt. Such a process may be iterative to make small adjustments to the image at each iteration as guided by the textual instructions, thereby ensuring the recolored image gradually approaches the desired result. For image recoloring in particular, the image generator 224 may identify areas of the image where the color changes should occur based on the text input. Using a combination of learned patterns (e.g., how the color of a particular object should look in different lighting conditions or contexts) and understanding of the input image may be used to apply new colors. In some cases, the final recolored image may be a subtle recoloring of specific regions. In other cases, the final recolored image may be a more drastic recoloring. Accordingly, such a final recolored image alters the input image according to the details in the text prompt, wherein the structural elements (e.g., shapes, objects, etc.) of the input image may be at least partially maintained.

The image-enhancing manager 226 is generally configured to enhance the recolored image generated via the image generator 224. In one embodiment, the image-enhancing manager 226 manages application of text to the recolored image generated via the image generator 224. In this regard, the image-enhancing manager 226 facilitates application of text, as well as the selection of the color and/or placement of the text. In this regard, the image-enhancing manager 226 can facilitate overlay of text into the recolored image to complete the image or design.

Generally, text coloring is selected or determined in a manner that facilitates readability of the text. For example, as the solid region in which text to be placed has a modified color as compared to the initial reference image, overlaying text of the same color as used in the initial reference image may result in text that is not visible, is difficult to view, or is aesthetically inconsistent with the new design colors.

As such, in one embodiment, to select a text color, colors from the recolored design may be randomly selected as text sample colors. For example, colors from different regions or areas within the recolored image may be randomly selected. A K-means color extraction may be performed to identify prominent colors from among the text sample colors. For instance, k-means clustering can be applied to group similar colors together to identify prominent colors. Such prominent colors may be designated as candidate text colors for each text box. Alternatively or additionally, specific colors may be designated as candidate text colors. For example, black and white, or other neutral colors, may be candidate text colors.

For each text region within an image (e.g., areas where text is to be presented within a bounding box), the median color within the bounding box may be identified. Such a median color may be the middle value when the colors inside the bounding box are arranged in order. As such, the median color provides an indication of the dominant color behind the text. Each candidate color may then be analyzed to ensure that the color will make the text legible. For example, the candidate color can be compared against the World Wide Web Consortium (W3C) color contrast guidelines to identify ideal contrast rations between text and background color to ensure readability. Colors with sufficient contrast between the background (text region) and the candidate text color are considered legible. In this regard, contrast ratios are determined, and colors that meet the contrast requirements are maintained as candidate text colors.

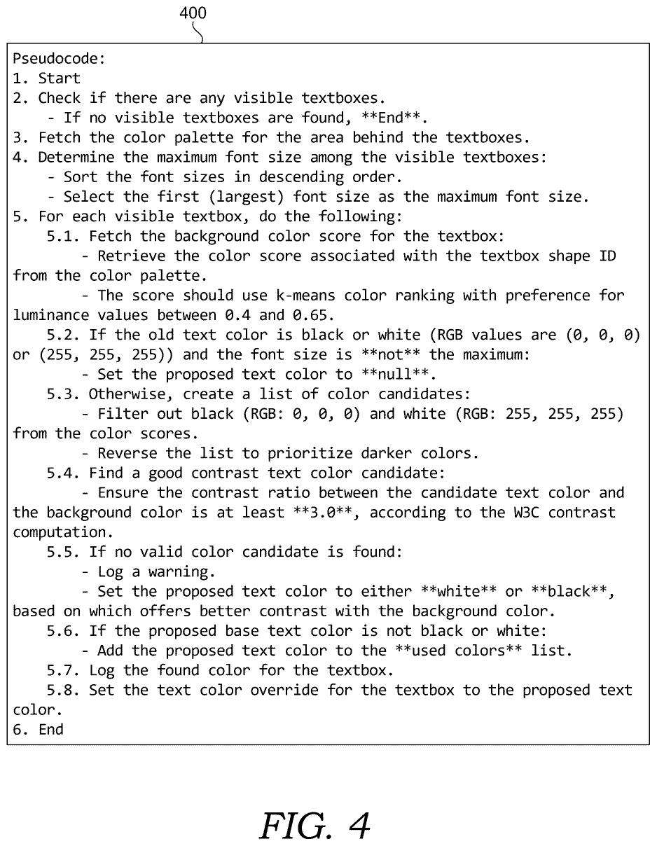

The image-enhancing manager 226 may then select a color from among the remaining candidate text colors. In some cases, such a color may be randomly selected. In other cases, the remaining candidate text colors may be ranked or scored to select a color. In embodiments, various attributes may be used to rank or score the candidate text colors. For example, luminance may be used to measure the brightness of the color. For instance, colors with luminance between 0.5 and 0.7 may be prioritized, as they tend to provide good readability. As another example, saturation may be used to measure the intensity or vividness of a color. For instance, colors with high saturation may be prioritized, as such colors tend to stand out. In some embodiments, both luminance and saturation may be used to select a color, as such text colors may provide legibility of text and also visually striking and harmonious text (e.g., relative to the image). FIG. 4 provides one example pseudocode 400 that may be used to identify or select text color for a recolored image.

In embodiments, the image-enhancing manager 226 may facilitate identification of the text description. For example, based on an input query, the image-enhancing manager 226 may generate or identify text to provide with the selected text color. For example, assume an invitation is desired to be designed for a 5^{th} birthday party. In such a case, the image-enhancing manager 226 may determine to include the text of “You are invited to celebrate a 5th birthday” and the corresponding text color to use for such text.

Based on a selected text color (e.g., a highest ranked candidate text color) and/or target text, the image-enhancing manager 226 may color the text in the text box(es) accordingly. For example, a final color selection for each text box may be made by selecting the most appropriate color from a list of legible and ranked candidate text colors. Based on such selections, the corresponding selected text colors are applied to text and overlayed onto the recolored image. In this way, an image is generated in accordance with desired colors of a user.

The image provider 228 is generally configured to provide data, such as image 270. In this regard, the image provider 228 may provide an image generated by the image generation manager 212. Such an image may include a recolored image (e.g., as generated via an image generator) with suitable text overlayed onto the recolored image (e.g., as generated via the image-enhancing manager). In this way, the image provider 228 provides data to be presented that is relevant to input data 260 (e.g., query 262 and/or reference image 264). In particular, the user may be presented with a desired image, in particular, in accordance with desired colors. The image provider 228 may provide the image to the user device via an appropriate interface.

In some cases, the image provider 228 may also provide additional data associated with the generated image. For example, the image provider 228 may provide an indication of color signals used, a text prompt, a reference image, a color-enhanced reference image, and/or the like. In this way, in addition to presenting a generated image, the user may also view identified data used to generate the image.

In some cases, the provided data, such as the generated image, may be provided for display. For example, a generated image may be presented via a user interface. Such data may be presented in any number of ways and formats. In addition or in the alternative to providing a generated image for presentation at a user device, the image provider 228 may provide such data to the user device, another system, component, or machine for further analysis, enhancing, and/or implementation. For example, a generated image may be automatically posted or stored for subsequent use by the user or other individuals or entities.

As discussed, various implementations and combinations of technologies may be used to implement various aspects related to generating images in accordance with a set of desired colors. In some cases, the particular technologies employed may depend on the application utilizing such technologies.

### Exemplary Implementations for Facilitating Effective Generation of Images Based on a Desired Color Set

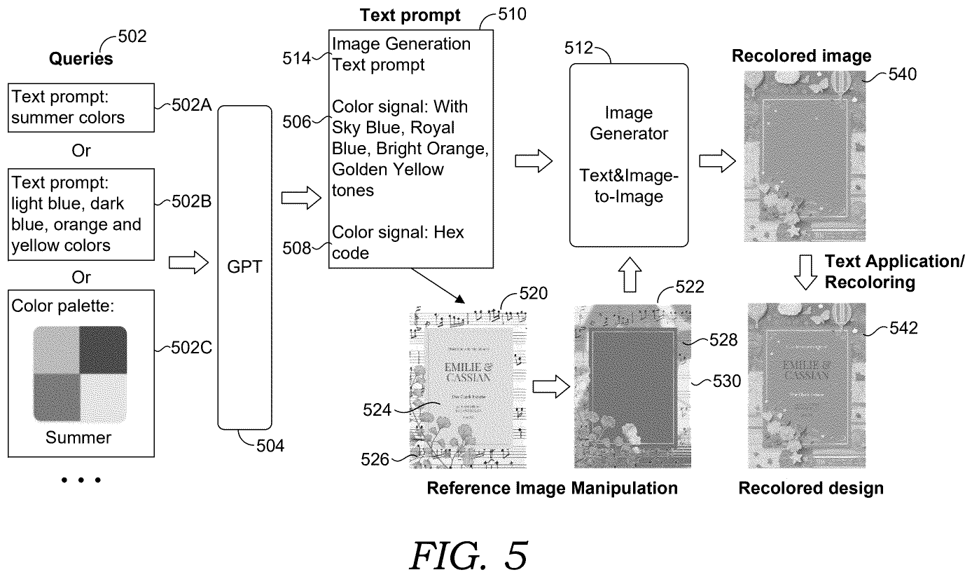

FIG. 5 provides an example flow diagram of one implementation that may be used for implementing embodiments of the present technology. As shown in FIG. 5, various types of queries 502 may be obtained and used as input to an AI model 504, such as an LLM (e.g., GPT-4). In this example, the queries may be in the form of a general text description 502A, a detailed text description 502B, and/or a set of colors 502C (e.g., a color palette) visually indicated or specified by color codes (hex code). Based on an input prompt to the AI model 504, the AI model 504 may output color signals, such as color signal 506 and color signal 508. In this example, color signal 508 is in the form of a text description of colors, and color signal 508 is in the form of a color code (e.g., hex code). The color signals 506 and 508 may be aggregated into a text prompt 510 for inputting to the image generator 512. In the example text prompt 510, additional text 514 describing other desired visual attributes for image generation is included. Now assume a reference image 520 is identified. In some cases, the reference image 520 may be selected by a user. In other cases, the reference image 520 may be automatically selected or determined.

In accordance with embodiments described herein, a color-enhanced reference image 522 can be generated based on the reference image 520 and colors, for instance, as specified via color signal 508. As shown, in this example, the solid region 524 may be identified in the reference image 520. Using a randomly selected desired color, in this case bright orange, the background or solid region may be filled in with bright orange color, as shown in the color-enhanced reference image 522. Further, the non-solid region 526 may be identified in the reference image 520. Such a non-solid region 526 may be segmented into various subregions. Using the desired colors, the subregions may be filled with random selections of the desired colors. For example, subregion 528 may be filled with the color royal blue, and subregion 530 may be filled with the color golden yellow.

The color-enhanced reference image 522 can be provided along with the text prompt 510 to an image generator 512, which may produce recolored image 540. As shown, text may be applied to the recolored image 540 to produce a final image 542. In applying the text to the recolored image, a text color may be determined and applied, such that the text is visible and visually appealing (e.g., corresponds with or is consistent with the desired colors).

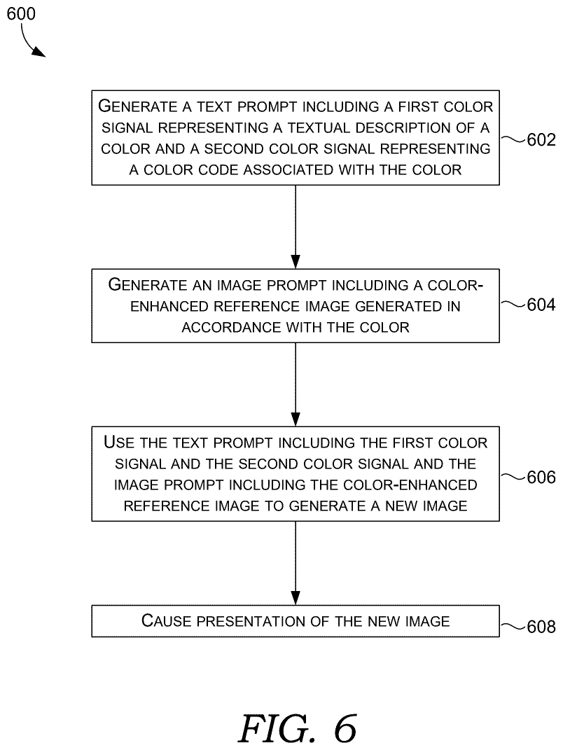

As described, various implementations can be used in accordance with embodiments described herein. FIGS. 6-8 provide methods of generating images in accordance with a desired set of colors, in accordance with embodiments described herein. The methods 600, 700, and 800 can be performed by a computer device, such as device 900 described below. The flow diagrams represented in FIGS. 6-8 are intended to be exemplary in nature and not limiting. For example, flow diagrams represented in FIGS. 6-8 represent various combinations of technologies and approaches used to manage identifying relevant code resource data and/or generating code, but are not intended to reflect all combinations of technologies and approaches that may be used in accordance with embodiments described herein.

With respect to FIG. 6, FIG. 6 provides an example method 600 flow for generating images in accordance with a desired set of colors, in accordance with embodiments described herein. At block 602, a text prompt including a first color signal representing a textual description of a color and a second color signal representing a color code associated with the color is generated. In embodiments, a text prompt may be generated based on an obtained query (e.g., a natural language text user input and/or a color code identified based on a user selection of a displayed color sample). In some examples, upon obtaining a query, a color prompt may be generated based on the query. The color prompt can be input into a generative AI model to obtain, as output, the first color signal and the second color signal for including in a text prompt. In this way, the text prompt input to an image generator is more robust to facilitate a more useful text prompt for the image generator.

At block 604, an image prompt including a color-enhanced reference image generated in accordance with the color is generated. In embodiments, the color-enhanced reference image may be generated using color codes associated with desired colors. As one example, upon obtaining a selection of a reference image (e.g., via a user), a solid region of the reference image may be identified. Thereafter, the solid region may be filled with one of the desired colors, and subregions of the non-solid regions filled with the various desired colors.

At block 606, the text prompt including the first color signal and the second color signal and the image prompt including the color-enhanced reference image is used to generate a new image. In some cases, generating the new image may also include identifying a text color for text to overlay a recolored image output by an image generator, such as a diffusion model, and incorporating the text color into text of the new image.

At block 608, the new image is presented. In this way, the generated new image may be presented on a display screen in response to an input query. In some cases, a set of new images may be generated and presented as candidates for the user.

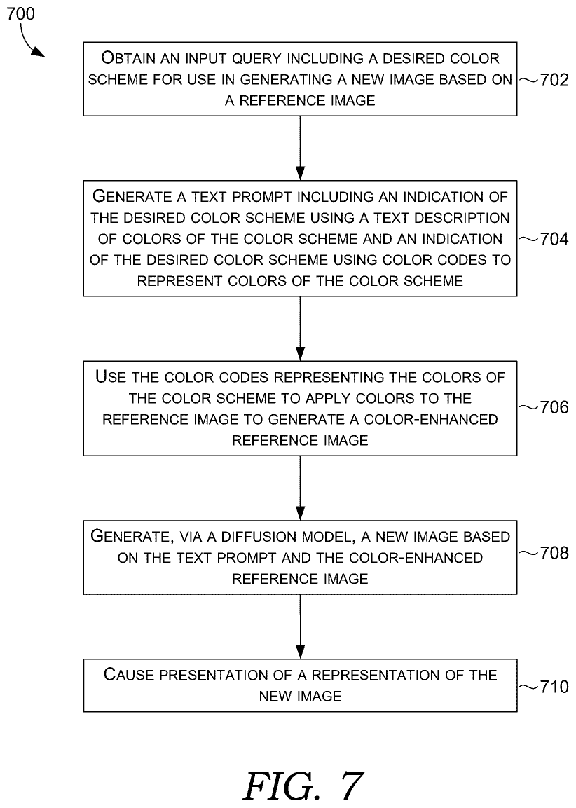

Turning to FIG. 7, FIG. 7 provides an example method 700 flow for generating images in accordance with desired colors, in accordance with embodiments described herein. Initially, at block 702, an input query including a desired color scheme for use in generating a new image based on a reference image is obtained.

At block 704, a text prompt including an indication of the desired color scheme using a text description of colors of the color scheme and an indication of the desired color scheme using color codes to represent colors of the color scheme is generated. In some embodiments, the color code for each color of the color scheme is obtained from the input query or generated via an AI model based on input query.

At block 706, the color codes representing the colors of the color scheme are used to apply colors to the reference image to generate a color-enhanced reference image. In some cases, a color-enhanced reference image is generated by applying one of the colors of the color scheme to fill in a solid region of the reference image and applying the colors of the color scheme to subregions of a non-solid region of the reference image.

At block 708, a new image is generated, via a diffusion model, based on the text prompt and the color-enhanced reference image. In this regard, a diffusion model can take as input the text prompt and the color-enhanced reference image and use the text prompt to adapt the color-enhanced reference image into a desired image.

At block 710, a representation of the new image is presented. In some cases, the representation of the new image includes text overlayed on the new image. In such cases, the text color may be determined for the text based on analysis of a set of colors sampled from the new image. For instance, colors can be sampled from the new image and compared to the background portion at which the text would be overlayed to identify a text color that would be visible and visually appealing.

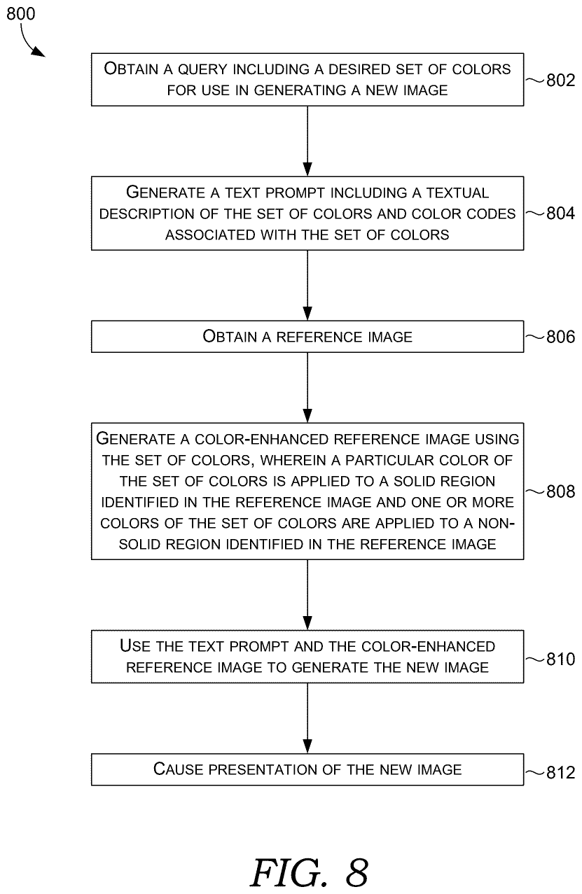

Turning to FIG. 8, FIG. 8 provides an example method flow 800 for generating images in accordance with a desired set of colors, in accordance with embodiments described herein. Initially, at block 802, a query including a desired set of colors for use in generating a new image is obtained. Such a desired set of colors may be specified using text and color codes (e.g., hex codes or RGB values). Such hex codes, RGB values, or other color codes are precise specifications of a color.

At block 804, a text prompt including a textual description of the set of colors and color codes associated with the set of colors is generated. To generate a text prompt, an AI model, such as an LLM, may be used to determine a more descriptive desired color and/or to generate color codes based on the text description of colors indicated in the query.

At block 806, a reference image is obtained. In some cases, a user may select a reference image to use. In other cases, a reference image may be automatically selected, for example, based on a user input. For example, assume a user desires to generate an invitation for a swim party. In such a case, an image of a swimming pool included on pregenerated invitations may be automatically selected as a reference image.

At block 808, a color-enhanced reference image is generated using the set of colors. In such a case, a particular color of the set of colors may be applied to a solid region identified in the reference image, and one or more colors of the set of colors may be applied to a non-solid region identified in the reference image. The particular color to use for the solid region may be randomly selected. Identifying a solid region may occur in any of a number of ways. As one example, pixels may be clustered in accordance with color values of the pixels and, thereafter, used to identify a dominant color of the reference image. A color value (e.g., an average or median color value) associated with the dominant color may be extracted. In this way, a mask may be generated for the solid region that includes the portions of the reference image that match the dominant color. Identifying colors for the non-solid region may also be performed in various manners. As one example, the non-solid region may be segmented into various subregions. Colors of the set of colors may be randomly applied to the various subregions. In some cases, the randomly applied colors are blended with a gray-scaled version of the reference image. Further, in some cases, edges may be extracted from the reference image and applied over a recolored reference image to generate the color-enhanced reference image.

At block 810, the text prompt and the color-enhanced reference image are used to generate the new image. For example, the text prompt and color-enhanced reference image may be provided as input to a diffusion model to generate a new image. Thereafter, at block 812, the new image is presented.

Accordingly, various aspects of technology are directed to systems, methods, and graphical user interfaces for intelligently generating images in accordance with desired colors. It is understood that various features, subcombinations, and modifications of the embodiments described herein are of utility and may be employed in other embodiments without reference to other features or subcombinations. Moreover, the order and sequences of steps shown in the example methods 600, 700, and 800 are not meant to limit the scope of the present disclosure in any way, and in fact, the steps may occur in a variety of different sequences within embodiments hereof. Such variations and combinations thereof are also contemplated to be within the scope of embodiments of this disclosure.

In some embodiments, a computing system is provided. The computing system can include a processor and computer storage memory having computer-executable instructions stored thereon that, when executed by the processor, configure the computing system to perform operations. In embodiments, the operations include generating a text prompt including a first color signal representing a textual description of a color and a second color signal representing a color code associated with the color. The operations further include generating an image prompt including a color-enhanced reference image generated in accordance with the color. The operations further include using the text prompt including the first color signal and the second color signal and the image prompt including the color-enhanced reference image to generate a new image. The operations further include causing presentation of the new image. Advantageously, using color-enhanced text and image inputs for image generation provides more efficient and effective images that incorporate desired colors, thereby reducing computer resource utilization.

In any combination of the above embodiments of the computing system, generating the text prompt comprises obtaining a query; generating a color prompt based on the query; providing the color prompt as input into a generative artificial intelligence model; obtaining, as output from the generative artificial intelligence model, the first color signal and the second color signal; and aggregating the first color signal and the second color signal into the text prompt.

In any combination of the above embodiments of the computing system, the query comprises a natural language text user input that textually describes the color.

In any combination of the above embodiments of the computing system, the query comprises a color code identified based on a user selection of a displayed color sample.

In any combination of the above embodiments of the computing system, the color-enhanced reference image is generated using the second color signal representing the color code associated with the color.

In any combination of the above embodiments of the computing system, the color-enhanced reference image is generated by obtaining a selection of a reference image; identifying a solid region of the reference image; filling the solid region with the color; generating subregions of one or more non-solid regions; and filling the non-solid regions with one or more colors indicated in the text prompt.

In any combination of the above embodiments of the computing system, generating the new image further includes identifying a text color for text of the new image based on one or more colors sampled from the new image and incorporating the text color into text of the new image.

In any combination of the above embodiments of the computing system, the text prompt further includes an image attribute signal based on a user input text query.

In other embodiments, a computer-implemented method is provided. The method includes obtaining an input query including a desired color scheme for use in generating a new image based on a reference image. The method also includes generating a text prompt including an indication of the desired color scheme using a text description of colors of the color scheme and an indication of the desired color scheme using color codes to represent colors of the color scheme. The method also includes using the color codes representing the colors of the color scheme to apply colors to the reference image to generate a color-enhanced reference image. The method further includes generating, via a diffusion model, a new image based on the text prompt and the color-enhanced reference image. The method also includes causing presentation of a representation of the new image. Advantageously, using color-enhanced text and image inputs for image generation provides more efficient and effective images that incorporate desired colors, thereby reducing computer resource utilization.

In any combination of the above embodiments of the computer-implemented method, the color code for each color of the color scheme is obtained from the input query or generated via an artificial intelligence model based on input query.

In any combination of the above embodiments of the computer-implemented method, generating the color-enhanced reference image comprises applying one of the colors of the color scheme to fill in a solid region of the reference image and applying the colors of the color scheme to subregions of a non-solid region of the reference image.

In any combination of the above embodiments of the computer-implemented method, the representation of the new image includes text overlayed on the new image.

In any combination of the above embodiments of the computer-implemented method, a text color is determined for the text based on analysis of a set of colors sampled from the new image.

In other embodiments, one or more computer storage media having computer-executable instructions embodied thereon that, when executed by one or more processors, cause the one or more processors to perform a method are provided. The method includes obtaining a query including a desired set of colors for use in generating a new image. The method also includes generating a text prompt including a textual description of the set of colors and color codes associated with the set of colors. The method also includes obtaining a reference image. The method further includes generating a color-enhanced reference image using the set of colors, wherein a particular color of the set of colors is applied to a solid region identified in the reference image, and one or more colors of the set of colors are applied to a non-solid region identified in the reference image. The method further includes using the text prompt and the color-enhanced reference image to generate the new image. The method further includes causing presentation of the new image. Advantageously, using color-enhanced text and image inputs for image generation provides more efficient and effective images that incorporate desired colors, thereby reducing computer resource utilization.

In any combination of the above embodiments of the media, the desired set of colors are specified using text and the color codes.

In any combination of the above embodiments of the media, generating the text prompt includes determining, via a generative artificial intelligence model, the color codes using the textual description of the set of colors included in the query.

In any combination of the above embodiments of the media, the particular color is randomly selected from the set of colors.

In any combination of the above embodiments of the media, identifying the solid region comprises clustering pixels in accordance with color values associated with the pixels; identifying a dominant color of the reference image based on a cluster of pixels that contains the most pixels; extracting a color value associated with the dominant color; and generating a mask for the solid region that includes portions of the reference image that match the dominant color.

In any combination of the above embodiments of the media, the one or more colors of the set of colors applied to the non-solid region identified in the reference image comprise segmenting the non-solid regions into subregions; randomly applying the one or more colors to the subregions; and blending the randomly applied colors with a gray-scaled version of the reference image.

In any combination of the above embodiments of the media, the method further comprises extracting edges from the reference image; and applying the extracted edges over a recolored reference image to generate the color-enhanced reference image used to generate the new image.

### Overview of Exemplary Operating Environments

Having briefly described an overview of aspects of the technology described herein, an exemplary operating environment in which aspects of the technology described herein may be implemented is described below in order to provide a general context for various aspects of the technology described herein.

Referring to the drawings in general, and to FIG. 9 in particular, an exemplary operating environment for implementing aspects of the technology described herein is shown and designated generally as computing device 900. Computing device 900 is just one example of a suitable computing environment and is not intended to suggest any limitation as to the scope of use or functionality of the technology described herein, and nor should the computing device 900 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 9, computing device 900 includes a bus 910 that directly or indirectly couples the following devices: memory 912, one or more processors 914, one or more presentation components 916, input/output (I/O) ports 918, I/O components 920, an illustrative power supply 922, and a radio(s) 924. Bus 910 represents what may be one or more buses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The diagram of FIG. 9 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 9 and refer to “computer” or “computing device.”

Computing device 900 typically includes a variety of computer-readable media. Computer-readable media can be any available media that can be accessed by computing device 900 and includes both volatile and non-volatile, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVDs) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 912 includes computer storage media in the form of volatile and/or non-volatile memory. The memory 912 may be removable, non-removable, or a combination thereof. Exemplary memory includes solid-state memory, hard drives, and optical-disc drives. Computing device 900 includes one or more processors 914 that read data from various entities such as bus 910, memory 912, or I/O components 920. Presentation component(s) 916 present data indications to a user or other device. Exemplary presentation components 916 include a display device, speaker, printing component, and vibrating component. I/O port(s) 918 allow computing device 900 to be logically coupled to other devices including I/O components 920, some of which may be built-in.

Illustrative I/O components include a microphone, joystick, game pad, satellite dish, scanner, printer, display device, wireless device, a controller (such as a keyboard and a mouse), a natural user interface (NUI) (such as touch interaction, pen [or stylus] gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 914 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 900. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 900. The computing device 900 may be equipped with depth cameras, such as stereoscopic camera systems, infrared camera systems, RGB camera systems, and combinations of these, for gesture detection and recognition. Additionally, the computing device 900 may be equipped with accelerometers or gyroscopes that enable detection of motion. The output of the accelerometers or gyroscopes may be provided to the display of the computing device 900 to render immersive augmented reality or virtual reality.

A computing device may include radio(s) 924. The radio 924 transmits and receives radio communications. The computing device may be a wireless terminal adapted to receive communications and media over various wireless networks. Computing device 900 may communicate via wireless protocols, such as code-division multiple access (“CDMA”), Global System for Mobiles (“GSM”), or time-division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

Turning to FIG. 10, FIG. 10 is a block diagram of a language model 1000 (for example, a BERT model or Generative Pre-trained Transformer [GPT]-4 model) that uses particular inputs to make particular predictions (for example, answers to questions), according to some embodiments. In one embodiment, the language model 1000 corresponds to, for example, the color signal identifier 232 of FIG. 2 described herein. In various embodiments, the language model 1000 includes one or more encoders and/or decoder blocks 1006 (or any transformer or portion thereof).

First, a natural language corpus (for example, various WIKIPEDIA English words or BooksCorpus) of the inputs 1001 are converted into tokens and then feature vectors and embedded into an input embedding 1002 to derive meaning of individual natural language words (for example, English semantics) during pre-training. In some embodiments, to understand English language, corpus documents, such as text books, periodicals, blogs, social media feeds, and the like are ingested by the language model 1000.

In some embodiments, each word or character in the input(s) 1001 is mapped into the input embedding 1002 in parallel or at the same time, unlike existing long short-term memory (LSTM) models, for example. The input embedding 1002 maps a word to a feature vector representing the word. But the same word (for example, “apple”) in different sentences may have different meanings (for example, brand versus fruit). This is why a positional encoder 1004 can be implemented. A positional encoder 1004 is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sine/cosine function to generate the positional encoder vector using the following two example equations:

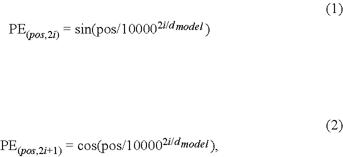

After passing the input(s) 1001 through the input embedding 1002 and applying the positional encoder 1004, the output is a word embedding feature vector, which encodes positional information or context based on the positional encoder 1004. These word embedding feature vectors are then passed to the encoder and/or decoder block(s) 1006, where it goes through a multi-head attention layer 1006-1 and a feedforward layer 1006-2. The multi-head attention layer 1006-1 is generally responsible for focusing or processing certain parts of the feature vectors representing specific portions of the input(s) 1001 by generating attention vectors. For example, in Question Answering systems, the multi-head attention layer 1006-1 determines how relevant the i^{th} word (or particular word in a sentence) is for answering the question or its relevance to other words in the same or other blocks, the output of which is an attention vector. For every word, some embodiments generate an attention vector, which captures contextual relationships between other words in the same sentence or other sequences of characters. For a given word, some embodiments compute a weighted average or otherwise aggregate attention vectors of other words that contain the given word (for example, other words in the same line or block) to compute a final attention vector.

In some embodiments, a single-headed attention has abstract vectors Q, K, and V that extract different components of a particular word. These are used to compute the attention vectors for every word, using the following equation (3):

$$Z = softmax ( \frac{Q , {K}^{T}}{\sqrt{Dimension of vector Q , K , o r V}} ) \cdot V . \qquad ( 3 )$$

For multi-headed attention, there are multiple weight matrices W^{q}, W^{k}, and W^{y}, so there are multiple attention vectors Z for every word. However, a neural network may expect one attention vector per word. Accordingly, another weighted matrix, W^{z}, is used to make sure the output is still an attention vector per word. In some embodiments, after the layers 1006-1 and 1006-2, there is some form of normalization (for example, batch normalization and/or layer normalization) performed to smoothen out the loss surface, making it easier to optimize while using larger learning rates.

Layers 1006-3 and 1006-4 represent residual connection and/or normalization layers where normalization recenters and rescales or normalizes the data across the feature dimensions. The feedforward layer 1006-2 is a feedforward neural network that is applied to every one of the attention vectors outputted by the multi-head attention layer 1006-1. The feedforward layer 1006-2 transforms the attention vectors into a form that can be processed by the next encoder block or that can make a prediction at output 1008. For example, given that a document includes a first natural language sequence “the due date is . . . ,” the encoder/decoder block(s) 1006 predicts that the next natural language sequence will be a specific date or particular words based on past documents that include language identical or similar to the first natural language sequence.

In some embodiments, the encoder/decoder block(s) 1006 includes pre-training to learn language (pre-training) and make corresponding predictions. In some embodiments, there is no fine-tuning because some embodiments perform prompt engineering or learning. Pre-training is performed to understand language, and fine-tuning is performed to learn a specific task, such as learning an answer to a set of questions (in Question Answering [QA] systems).

In some embodiments, the encoder/decoder block(s) 1006 learns what language and context for a word are in pre-training by training on two unsupervised tasks (Masked Language Model [MLM] and Next Sentence Prediction [NSP]) simultaneously or at the same time. In terms of the inputs and outputs, at pre-training, the natural language corpus of the inputs 1001 may be various historical documents, such as text books, journals, and periodicals, in order to output the predicted natural language characters in 1008 (not make the predictions at runtime or prompt engineering at this point). The example encoder/decoder block(s) 1006 takes in a sentence, paragraph, or sequence (for example, included in the input[s] 1001), with random words being replaced with masks. The goal is to output the value or meaning of the masked tokens. For example, if a line reads, “please [MASK] this document promptly,” the prediction for the “mask” value is “send.” This helps the encoder/decoder block(s) 1006 understand the bidirectional context in a sentence, paragraph, or line in a document. In the case of NSP, the encoder/decoder block(s) 1006 takes, as input, two or more elements, such as sentences, lines, or paragraphs, and determines, for example, if a second sentence in a document actually follows (for example, is directly below) a first sentence in the document. This helps the encoder/decoder block(s) 1006 understand the context across all the elements of a document, not just within a single element. Using both of these together, the encoder/decoder block(s) 1006 derives a good understanding of natural language.

In some embodiments, during pre-training, the input to the encoder/decoder block(s) 1006 is a set (for example, two) of masked sentences (sentences for which there are one or more masks), which could alternatively be partial strings or paragraphs. In some embodiments, each word is represented as a token, and some of the tokens are masked. Each token is then converted into a word embedding (for example, 1002). At the output side is the binary output for the next sentence prediction. For example, this component may output 1, for example, if masked sentence 2 follows (for example, is directly beneath) masked sentence 1. The outputs are word feature vectors that correspond to the outputs for the machine learning model functionality. Thus, the number of word feature vectors that are input is the same number of word feature vectors that are output.

In some embodiments, the initial embedding (for example, the input embedding 802) is constructed from three vectors: the token embeddings, the segment or context-question embeddings, and the position embeddings. In some embodiments, the following functionality occurs in the pre-training phase. The token embeddings are the pre-trained embeddings. The segment embeddings are the sentence numbers (including the input[s] 1001) that are encoded into a vector (for example, first sentence, second sentence, and so forth, assuming a top-down and right-to-left approach). The position embeddings are vectors that represent the position of a particular word in such a sentence that can be produced by positional encoder 1004. When these three embeddings are added or concatenated together, an embedding vector is generated that is used as input into the encoder/decoder block(s) 806. The segment and position embeddings are used for temporal ordering since all of the vectors are fed into the encoder/decoder block(s) 1006 simultaneously, and language models need some sort of order preserved.

In pre-training, the output is typically a binary value C (for NSP) and various word vectors (for MLM). With training, a loss (for example, cross-entropy loss) is minimized. In some embodiments, all the feature vectors are of the same size and are generated simultaneously. As such, each word vector can be passed to a fully connected layered output with the same number of neurons equal to the same number of tokens in the vocabulary.

In some embodiments, after pre-training is performed, the encoder/decoder block(s) 1006 performs prompt engineering or fine-tuning on a variety of QA data sets by converting different QA formats into a unified sequence-to-sequence format. For example, some embodiments perform the QA task by adding a new question answering head or encoder/decoder block, just the way a masked language model head is added (in pre-training) for performing an MLM task, except that the task is a part of prompt engineering or fine-tuning. This includes the encoder/decoder block(s) 1006 processing the inputs 1003A and/or 1003B in order to make the predictions and generate a prompt response, as indicated in 1004. Prompt engineering, in some embodiments, is the process of crafting and optimizing text prompts for language models to achieve desired outputs. In other words, prompt engineering comprises a process of mapping prompts (for example, a question) to the output (for example, an answer) that it belongs to for training. For example, if a user asks a model to generate a poem about a person fishing on a lake, the expectation is it will generate a different poem each time. Users may then label the output or answers from best to worst. Such labels are an input to the model to make sure the model is giving more human-like or best answers, while trying to minimize the worst answers (for example, via reinforcement learning). In some embodiments, a “prompt” as described herein includes one or more of: a request (for example, a question or instruction [for example, “write a poem”]), target content, and one or more examples, as described herein.

The technology described herein has been described in relation to particular aspects, which are intended in all respects to be illustrative rather than restrictive.

What is claimed is:

1. A computing system comprising:
a processor; and
computer storage memory having computer-executable instructions stored thereon that, when executed by the processor, configure the computing system to perform operations comprising:
generating a text prompt including a first color signal representing a textual description of a color and a second color signal representing a color code associated with the color;
generating an image prompt including a color-enhanced reference image generated in accordance with the color;
using the text prompt including the first color signal and the second color signal and the image prompt including the color-enhanced reference image to generate a new image; and
causing presentation of the new image.

2. The computing system of claim 1, wherein generating the text prompt comprises:
obtaining a query;
generating a color prompt based on the query;
providing the color prompt as input into a generative artificial intelligence model;
obtaining, as output from the generative artificial intelligence model, the first color signal and the second color signal; and
aggregating the first color signal and the second color signal into the text prompt.

3. The computing system of claim 2, wherein the query comprises a natural language text user input that textually describes the color.

4. The computing system of claim 2, wherein the query comprises a color code identified based on a user selection of a displayed color sample.

5. The computing system of claim 1, wherein the color-enhanced reference image is generated using the second color signal representing the color code associated with the color.

6. The computing system of claim 1, wherein the color-enhanced reference image is generated by:
obtaining a selection of a reference image;
identifying a solid region of the reference image;
filling the solid region with the color;
generating subregions of one or more non-solid regions; and
filling the non-solid regions with one or more colors indicated in the text prompt.

7. The computing system of claim 1, wherein generating the new image further includes:
identifying a text color for text of the new image based on one or more colors sampled from the new image; and
incorporating the text color into text of the new image.

8. The computing system of claim 1, wherein the text prompt further includes an image attribute signal based on a user input text query.

9. A computer-implemented method comprising:
obtaining an input query including a desired color scheme for use in generating a new image based on a reference image;
generating a text prompt including an indication of the desired color scheme using a text description of colors of the color scheme and an indication of the desired color scheme using color codes to represent colors of the color scheme;
using the color codes representing the colors of the color scheme to apply colors to the reference image to generate a color-enhanced reference image;
generating, via a diffusion model, a new image based on the text prompt and the color-enhanced reference image; and
causing presentation of a representation of the new image.

10. The computer-implemented method of claim 9, wherein the color code for each color of the color scheme is obtained from the input query or generated via an artificial intelligence model based on input query.

11. The computer-implemented method of claim 9, wherein generating the color-enhanced reference image comprises applying one of the colors of the color scheme to fill in a solid region of the reference image and applying the colors of the color scheme to subregions of a non-solid region of the reference image.

12. The computer-implemented method of claim 9, wherein the representation of the new image includes text overlayed on the new image.

13. The computer-implemented method of claim 12, wherein a text color is determined for the text based on analysis of a set of colors sampled from the new image.

14. One or more computer storage media having computer-executable instructions embodied thereon that, when executed by one or more processors, cause the one or more processors to perform a method, the method comprising:
obtaining a query including a desired set of colors for use in generating a new image;
generating a text prompt including a textual description of the set of colors and color codes associated with the set of colors;
obtaining a reference image;
generating a color-enhanced reference image using the set of colors, wherein a particular color of the set of colors is applied to a solid region identified in the reference image and one or more colors of the set of colors are applied to a non-solid region identified in the reference image;
using the text prompt and the color-enhanced reference image to generate the new image; and
causing presentation of the new image.

15. The media of claim 14, wherein the desired set of colors are specified using text and the color codes.

16. The media of claim 14, wherein generating the text prompt includes determining, via a generative artificial intelligence model, the color codes using the textual description of the set of colors included in the query.

17. The media of claim 14, wherein the particular color is randomly selected from the set of colors.

18. The media of claim 14, wherein identifying the solid region comprises:
clustering pixels in accordance with color values associated with the pixels;
identifying a dominant color of the reference image based on a cluster of pixels that contains the most pixels;
extracting a color value associated with the dominant color; and
generating a mask for the solid region that includes portions of the reference image that match the dominant color.

19. The media of claim 14, wherein the one or more colors of the set of colors applied to the non-solid region identified in the reference image comprise:
segmenting the non-solid region into subregions;
randomly applying the one or more colors to the subregions; and
blending the randomly applied colors with a gray-scaled version of the reference image.

20. The media of claim 19, further comprising:
extracting edges from the reference image; and
applying the extracted edges over a recolored reference image to generate the color-enhanced reference image used to generate the new image.
